(19) United States
(12) Patent Application Publication
(10) Pub. No.: US 2016/0010710 A1
(43) Pub. Date: Jan. 14, 2016

(54) MECHANICAL DISC BRAKE

(71) Applicant: Yung-Pin Kuo, Changhua County (TW)

(72) Inventor: Yung-Pin Kuo, Changhua County (TW)

(21) Appl. No.: 14/326,472

(22) Filed: Jul. 9, 2014

(51) Int. Cl. F16D 65/14; F16D 65/00

(52) U.S. Cl. CPC F16D 65/14; F16D 65/0068; F16D 2121/14

(57) ABSTRACT

A mechanical disk brake is disclosed, including a cylinder body, a brake pad, a piston, a cam disc and balls, where the structure design is as follows: cylinder body being provided with positioning gouges, the cam disc having a multi-section trench, and the balls being located between the positioning gouges and the multi-section trench, which enables the cam disc to be controlled for rotation which abuts against the piston and in turn to press against the brake pad for engaging a brake. The ball moves in the multi-section trench, which enables the cam disc to feature multiple axial displacements, thus to provide multiple sectional braking effect. This invention not only avoids the prior deadlock of the brake, but offers multiple segments of gradual braking effect, which offers the user multiple segments of tactual sensation.

### BACKGROUND OF THE INVENTION

1. Field of the Invention

This invention relates generally to bike brakes and more specifically to one that features mechanical disc brake of bikes.

2. Description of Related Art

The moving mechanism of bikes primarily includes a chain wheel attaching to the frame, a free wheel attaching to the rear-wheel, and a chain encircling around the chain wheel and the free wheel. Once the pedal, attached to the crank that extends from the chain wheel, is stamped, the chain wheel is driven to roll which drives the free wheel of the rear-wheel by means of the chain so that the rear-wheel is responsible for powering the bicycle to move. If a bike is intended to slow down or stop from moving, a bike brake is to be operated, where common brake apparatus are categorized into the types of conventional friction wheel rim and disc brake.

A disk brake forms by generally a metal disk assembled coaxially in the hub of the wheel set and a disk brake caliper mounted at the front fork or rear fork adjacent to the hub for the clamping of the metal disk, which makes use of frictional force to mitigate or stop the rotation of the metal disk. Since the cooling effect of the metal disk is fabulous and the braking force is better than that of the friction wheel rim; therefore, disk brake is the preferred selection for quality brake apparatus of the bikes, which gains popularity.

Therefore, brake apparatus have become part of the important aspects of bicycle safety, and many bike manufacturers lay much stress on quality and improvement of the brakes, followed by research and development for the brakes, to assure bike riders to have great braking effect during riding the bike, which substantially boosts bike safety.

However, different status of roads calls for different degree of operating the brake, for example, a distant red traffic light requires smooth braking for the slow deceleration while a sudden crossed child or animal requires prompt braking for the immediate stop to avoid accident. But the brake handle on the bicycle handlebar generally makes use of pulling brake line to control the disk brake caliber to clamp the disk. Therefore, for those unfamiliar or new to the disk brakes, a sudden and exceeding pressing on the brake would lead to a deadlock of the disk by the disc brake caliper, which for sure causes bike slippage that induces traffic accident.

In view of the drawbacks of the aforementioned examples, this inventor conceived deeply the idea to the research of the invention, the comparison of each advantage and disadvantage with the prior art, and the development of the relating products, and eventually the longtime endeavors gave birth to “Mechanical Disk Brake” of this invention, which improves the aforementioned drawbacks, to suit the use of nowadays.

### SUMMARY OF THE INVENTION

The primary objective of the present invention is to provide a mechanical disk brake that features multiple segments of braking effect, not only to avoid previous deadlocked state of brakes, but to get multiple segments of gradual braking effect, which offers the user multiple segments of tactual sensation, indeed a product of practicality.

To achieve the aforementioned objective and function, the mechanical disk brake of the present creation comprises a cylinder body, a brake pad, a piston, a cam disc, and balls, where the cylinder body is provided with an elongated trough and a containing hole penetrating throughout the cylinder body, and an inner periphery member is disposed in the containing hole, where the inner periphery member is coaxial to the containing hole. And positioning gouges are disposed at the inner periphery member; a brake pad, set in the elongated trough to clamp against the disc; one end of the piston is connected rotationally with the cam disc while the other end to abut against the brake pad; a cam disc, capable of being rotated and moved along the axial direction of the containing hole and disposed thereat, which drives the piston to move toward the brake pad or to move away from the brake pad. The cam disc is provided with a multi-section trench corresponding to the positioning gouges respectively; the multi-section trench comprises an initial slot, a first slot, a second slot and a third slot, where the cam disc is provided with a horizontal plane in the radial direction, wherein the angle between the bottom plane of the first slot and the horizontal plane is θ1, the angle between the bottom plane of the second slot and the horizontal plane is θ2, and the angle between the bottom plane of the third slot and the horizontal plane is θ3, where θ3>θ1>θ2, and the depth of the first slot is deeper than that of the second slot, and the depth of the second slot is deeper than that of the third slot, while the ball is disposed between the positioning gouge and the multi-section trench and rotates along the initial slot, the first slot, second slot and the third slot as the cam disc is rotated around the containing hole.

The mechanical disk brake is as above, wherein θ3>θ1>θ2 or θ2>θ1>θ3.

The mechanical disk brake as above, wherein cam disk comprises an outer periphery member and a bump is disposed at the outer periphery member, where the multi-section trench is disposed at the outer periphery member and the third slot is at the bump. The inner periphery member of the cylinder body comprises a wide bump toward the brake pad, and the positioning gouge is disposed at the wide bump.

The mechanical disk brake as above, wherein the horizontal plane is the surface that the cam disc contacts the piston.

### BRIEF DESCRIPTION OF THE DRAWINGS

FIG. 1 is a partially three-dimensional exploded diagram of a preferred embodiment of the present creation;

FIG. 2 is a three-dimensional diagram that the cam disc does not combine with the shell body of a preferred embodiment of the present creation;

FIG. 3 is a three-dimensional diagram of the assembly of a preferred embodiment of the present creation;

FIG. 4 is a schematic diagram of the depth position of the multi-section trench of the cam disc where the ball is located and the included angle θ of a preferred embodiment of the present creation;

FIG. 5 is a schematic diagram of the position change of the multi-section trench of the cam disc where the ball is located of a preferred embodiment of the present creation;

FIG. 6 is a schematic diagram that the present invention is not in the braking action of a preferred embodiment of the present creation; and

FIGS. 7-9 are schematic diagrams of the operation of the brake of the preferred embodiments of the present creation.

### DETAILED DESCRIPTION OF THE INVENTION

The mechanical disk brake of this invention is available to apply one-way and two-way friction to the disk for producing braking effect, and the following embodiments are based on bi-directional actuation.

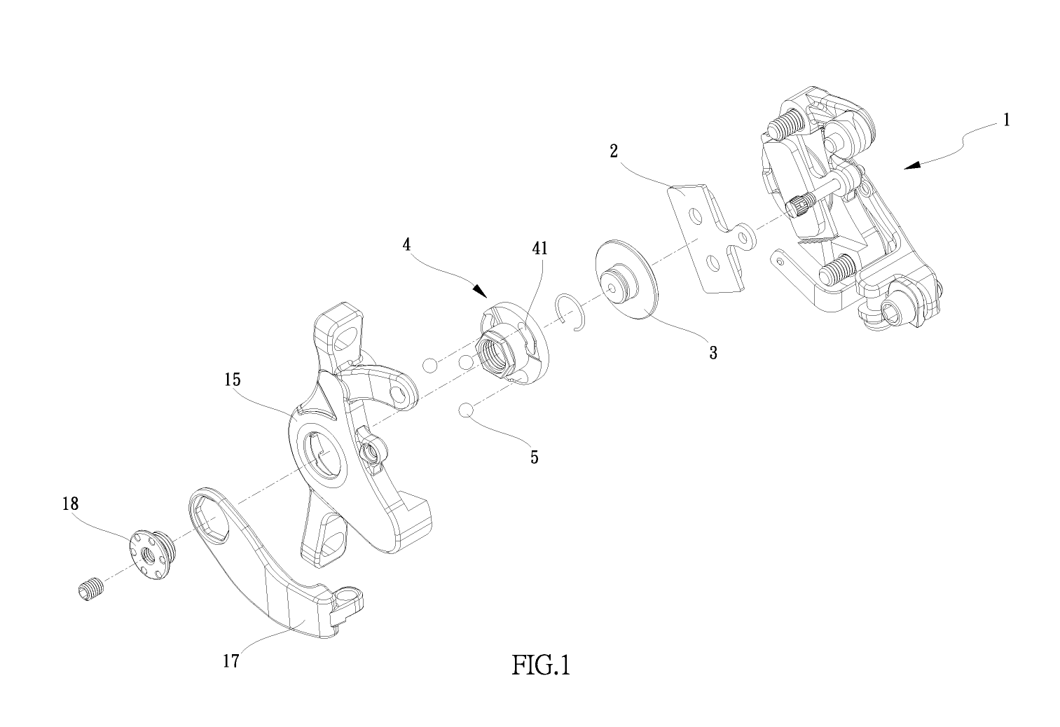

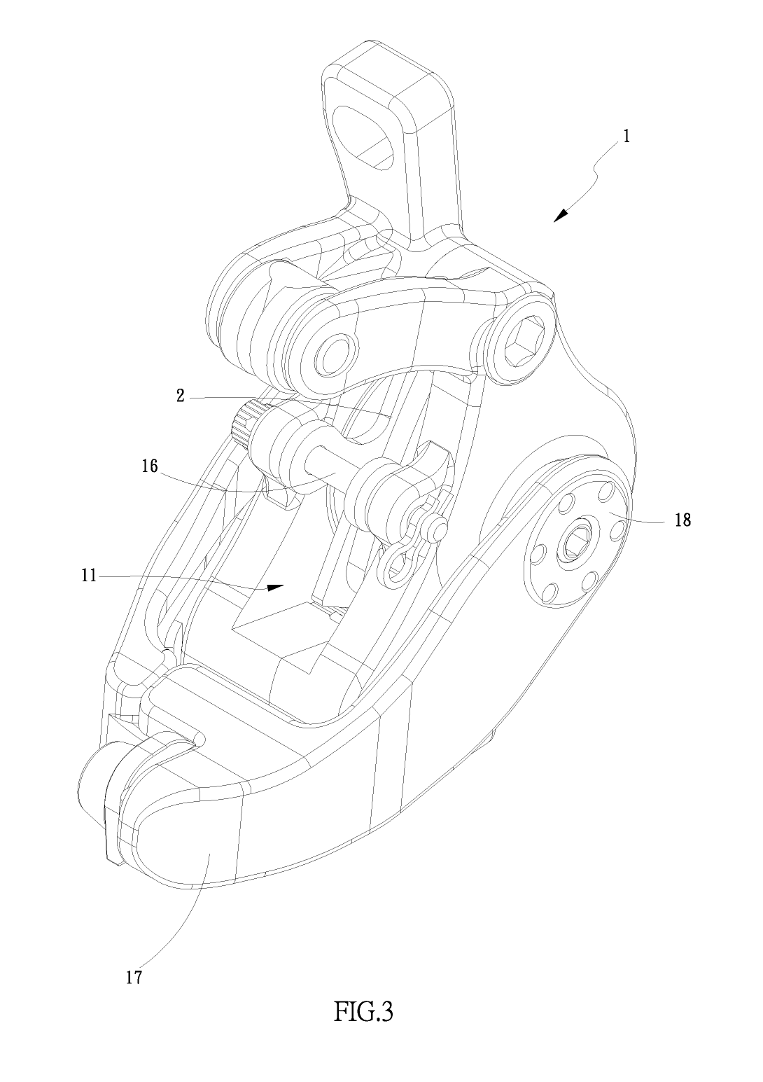

With reference to FIGS. 1-3, a preferred embodiment of the present invention, a mechanical disk brake, comprising: a cylinder body 1, brake pads 2, a piston 3, a cam disc 4, and balls 5, where the cylinder body 1 is provided with an elongated trough 11 and a containing hole 12 penetrating throughout the cylinder body 1, and an inner periphery member 13 is disposed in the containing hole 12, where the inner periphery member 13 is coaxial to the containing hole 12. And positioning gouges 14 are disposed at the inner periphery member 13; a brake pad 2, set in the elongated trough 11 to clamp against the disc; one end of the piston 3 is connected rotationally with the cam disc 4 while the other end to abut against the brake pad 2.

The cam disc 4, capable of being rotated and moved along the axial direction of the containing hole 12 and disposed thereat, which drives the piston 3 to move toward the brake pad 2 or to move away from the brake pad 2. The cam disc 4 is provided with a multi-section trench 41 corresponding to the positioning gouges 14 respectively.

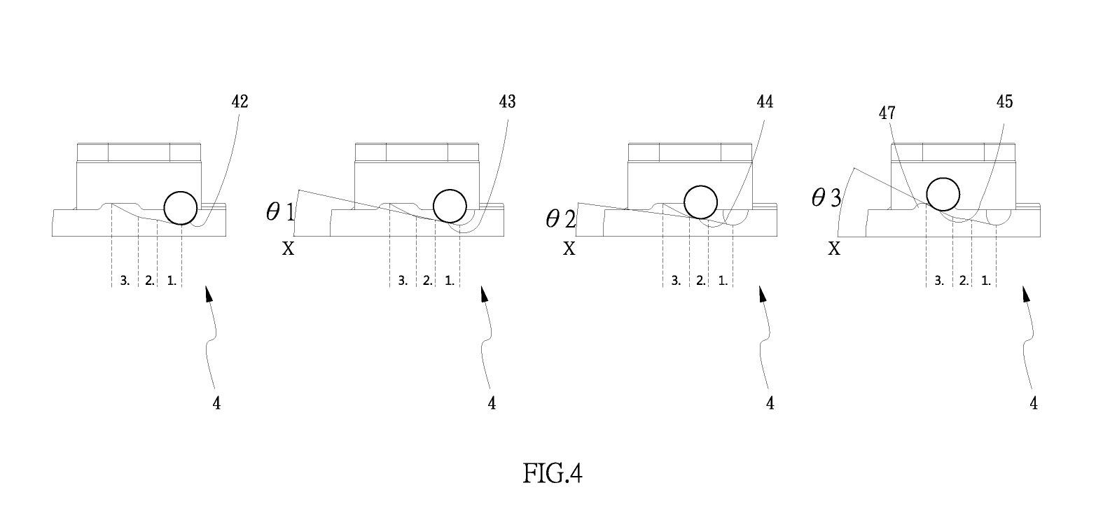

With reference to FIG. 4, the multi-section trench 41 comprises an initial slot 42, a first slot 43, a second slot 44 and a third slot 45, where the cam disc 4 is provided with a horizontal plane X in the radial direction, and the horizontal plane X is the surface that the cam disc 4 contacts the piston 3, wherein the angle between the bottom plane of the first slot 43 and the horizontal plane X is θ1, the angle between the bottom plane of the second slot 44 and the horizontal plane X is θ2, and the angle between the bottom plane of the third slot 45 and the horizontal plane X is θ3, where θ3>θ1>θ2, and the depth of the first slot 43 is deeper than that of the second slot 44, and the depth of the second slot 44 is deeper than that of the third slot 45, while the ball 5 is disposed between the positioning gouge 14 and the multi-section trench 41 and rotates along the first slot 43, second slot 44 and the third slot 45 as the cam disc 4 is rotated around the containing hole 12.

A further description of the rest parts of the present invention is given here, where the cylinder body 1 comprises two shell bodies 15 bonding to each other with a spindle 16 penetrating the brake pad 2 within the elongated trough 11, and the two ends of the spindle 16 is fixed on the shell bodies 15, and a rocking arm 17 is placed across the cylinder body 1 through the rocker arm screws 18 to lock on the cam disc 4. Once the rocking arm 17 is drawn by a brake line (not drawn), the rocking arm 17 swings with respect to the cam disc 4, which further enables the cam disc 4 to rotate around the containing hole 12 and to move along the axial direction of the containing hole 12. Two-way operated brake is prior technology which only briefly describes its actuation principle herewith.

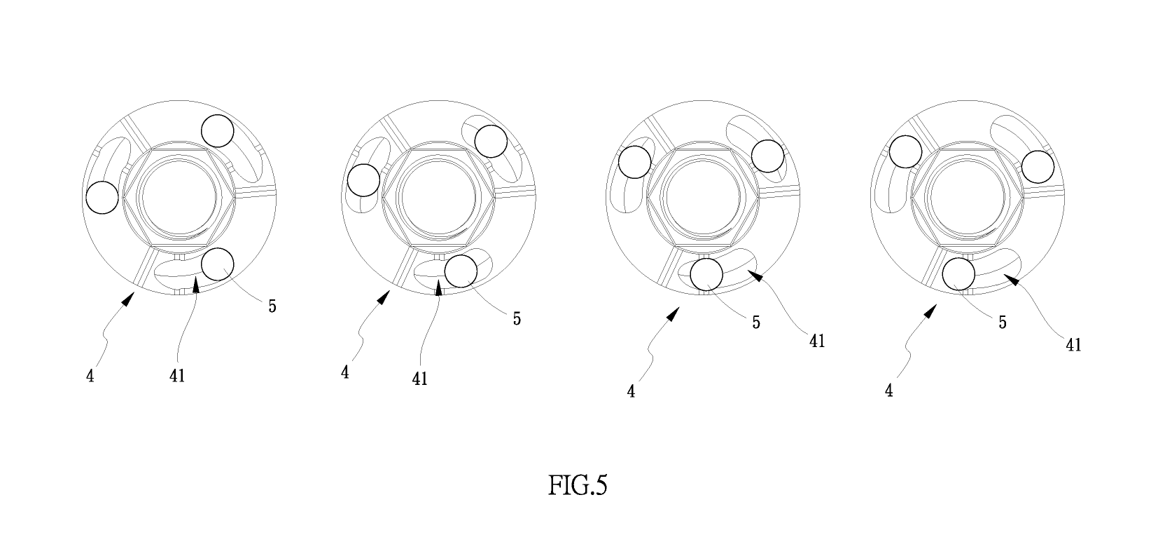

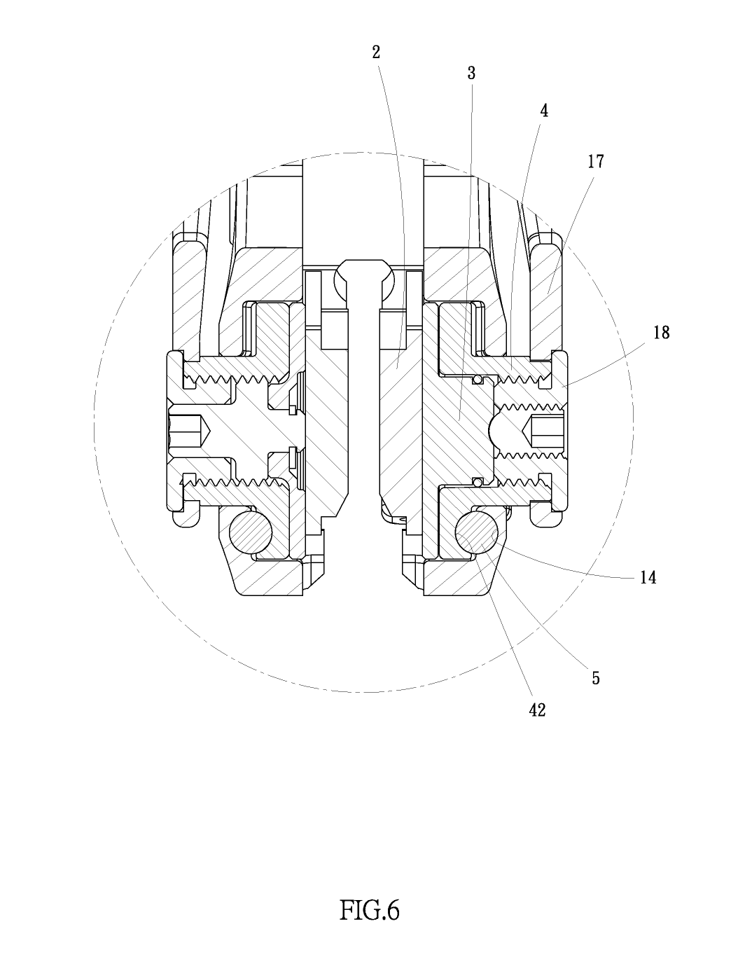

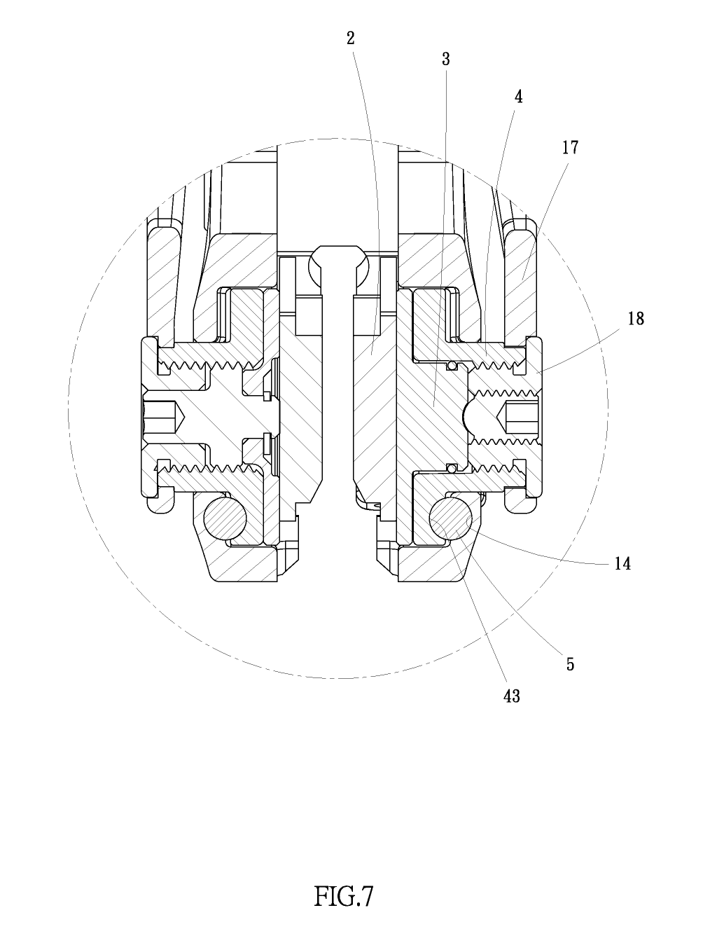

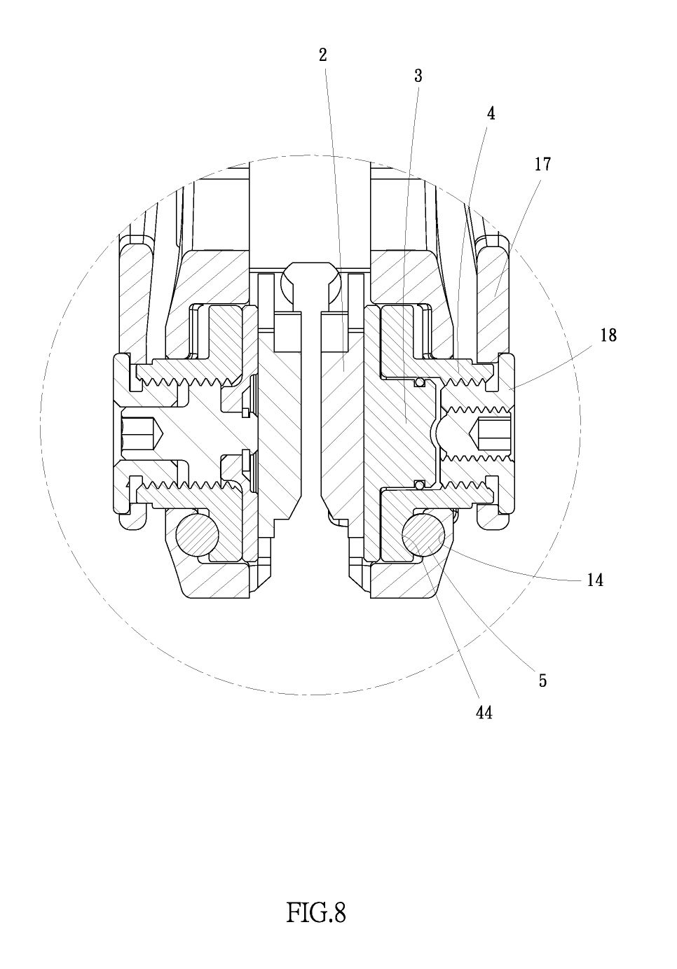

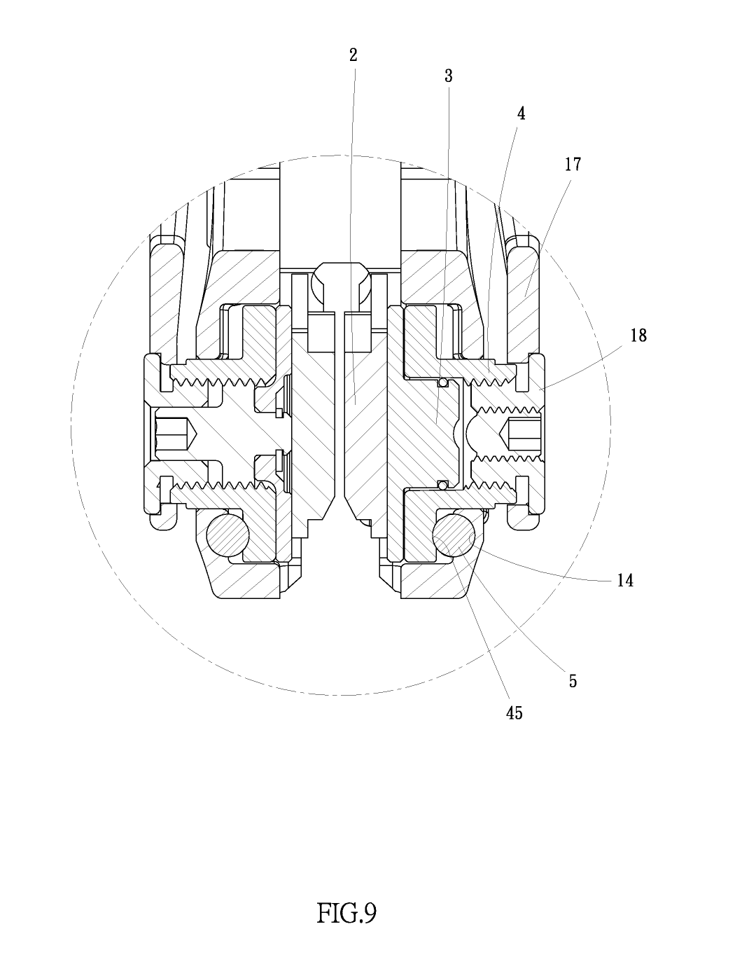

With reference to FIGS. 4-9, the operation of mechanical disc brake of the present invention refers to the actuation of the brake, where rocking arm 17 drives the cam disc 4 to rotate and to abut against the piston 3 which in turn abuts against the brake pad 2. The ball 5 moves in the multi-section trench 41, which forms multiple axial displacements for the cam disc 4, with which the cam disc 4 drives the piston 3 in a multiple stage to enable the piston 3 to press against the brake pad 2 that the generation of disc friction brings about the braking effect.

The above structure shows the cylinder body 1 being provided with positioning gouges 14, the cam disc 4 being provided with a multi-section trench 41, and the ball 5 being disposed between the positioning gouge 14 and the multi-section trench 41 so that the cam disc 4 is controlled for rotation to abut against the piston and in turn to press against the brake pad 2 for engaging a brake. Since the ball 5 moves in the multi-section trench 41 (the initial slot 42, the first slot 43, the slot 44, the second slot 44 and the third slot 45), which enables the cam disc 4 to feature multiple axial displacements, thus to provide multiple sectional braking effect. The ball 5 in the first slot 43 offers comfortable hand sensation, which achieves rapid deceleration that avoids excessive braking force causing bike slippage that changes the riding path. The ball 5 in the second slot 44 offers stiffer hand sensation. The ball 5 in the third slot 45 offers more pliable hand sensation than that of the second slot 44, which achieves prompt braking to stop. Therefore, this invention not only avoids the prior deadlock of the brake, but offers multiple segments of gradual braking effect, which offers the user multiple segments of tactual sensation, indeed a product of practicality.

With reference to FIG. 4, in the mechanical disk brake of this invention, θ1 is between 15° and 25°, θ2 is between 25° to 15°, θ3 is between 25° to 35°. Also, a preferred angle of θ1 is 20°, and a preferred angle of θ2 is 10° while that for θ3 is 30°. In addition, the aforesaid embodiments are based on the perspective of θ3>θ1>θ2, or θ2>θ1>θ3, which can achieve multiple sectional braking effect to avoid the prior deadlock of the brake.

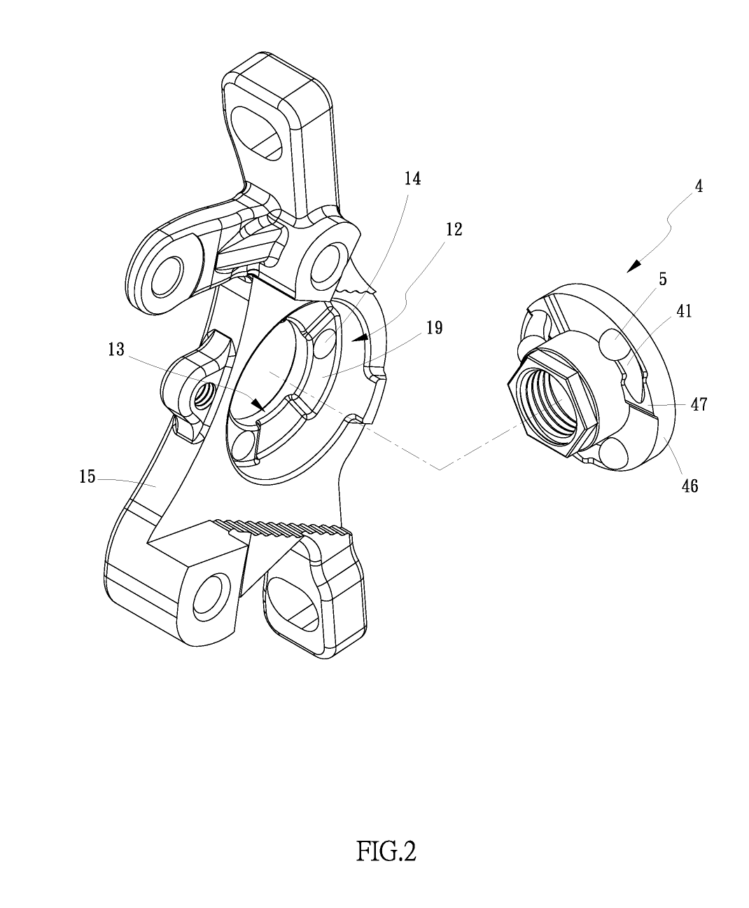

Referring again to FIGS. 2-4, the figure shows the cam disc 4 of the mechanical disk brake of the invention comprises an outer periphery member 46, and a bump 47 is disposed at the outer periphery member 46, where the multi-section trench 41 is disposed at the outer periphery member 46 and the third slot 45 is at the bump 47. The inner periphery member 13 of the cylinder body 1 comprises a wide bump 19 toward the brake pad 2, and the positioning gouges 14 are disposed at the wide bump 19. By means of the setup of the bump 47 of the cam disc 4 and the wide bump 19 of the cylinder body 1, the bump 47 is allowed to place in between two adjacent wide bump 19, which can effectively increase the combinational effect for the cam disc 4 and the cylinder body 1, and the bump 47 is limited within two adjacent wide bumps 19 as the cam disc 4 is rotated.

The foregoing description is the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the mechanical disk brake of this invention has not appeared in the prior art and features efficacy better than the prior structure which is construed to be a novel and creative invention, thereby filing the present application herein subject to the patent law.

What is claimed is:

1. A mechanical disk brake, comprising a cylinder body, a brake pad, a piston, a cam disc, and balls, wherein:
said cylinder body, provided with an elongated trough and a containing hole penetrating throughout said cylinder body, and an inner periphery member is disposed in the containing hole, where the inner periphery member is coaxial to the containing hole, and positioning gouges are disposed at the inner periphery member;
said brake pad, set in the elongated trough to clamp against a disc;
said piston, connected rotationally with said cam disc at an end thereof while abutting against said brake pad at the other end;
a cam disc, capable of being rotated and moved along axial direction of the containing hole and being disposed thereat, which drives said piston to move toward said brake pad for abutting or to move away from said brake pad, and said cam disc being provided with a multi-section trench corresponding to the positioning gouges respectively;
the multi-section trench comprises an initial slot, a first slot, a second slot and a third slot, where said cam disc is provided with a horizontal plane in a radial direction, wherein an angle between a bottom plane of the first slot and the horizontal plane is θ1, an angle between a bottom plane of the second slot and the horizontal plane is θ2, and an angle between a bottom plane of the third slot and the horizontal plane is θ3, where said balls each is disposed between the positioning gouge and the multi-section trench and rolls along the initial slot, the first slot, second slot and the third slot as said cam disc is rotated around the containing hole.

2. The mechanical disk brake as claimed in claim 1, wherein θ3>θ1>θ2.

3. The mechanical disk brake as claimed in claim 1, wherein θ2>θ1>θ3.

4. The mechanical disk brake as claimed in claim 1, wherein said cam disk comprises an outer periphery member and a bump is disposed thereat, where the multi-section trench is disposed at the outer periphery member and the third slot is at the bump.

5. The mechanical disk brake as claimed in claim 4, wherein the inner periphery member comprises a wide bump disposed toward said brake pad, and the positioning gouges each is disposed at the wide bump.

6. The mechanical disk brake as claimed in claim 1, wherein the horizontal plane is a surface that said cam disc contacts said piston.

7. The mechanical disk brake as claimed in claim 5, wherein the horizontal plane is a surface that said cam disc contacts said piston.
